(19) United States
(12) Patent Application Publication
(10) Pub. No.: US 2016/0205470 A1
(43) Pub. Date: Jul. 14, 2016

(54) CONDENSER MICROPHONE UNIT AND CONDENSER MICROPHONE

(71) Applicant: Hiroshi AKINO, Tokyo (JP)

(72) Inventor: Hiroshi AKINO, Tokyo (JP)

(73) Assignee: KABUSHIKI KAISHA AUDIO-TECHNICA, Tokyo (JP)

(21) Appl. No.: 14/989,281

(22) Filed: Jan. 6, 2016

(30) Foreign Application Priority Data
Jan. 8, 2015 (JP) 2015-002148

(51) Int. Cl. H04R 3/00; H04R 7/10

(52) U.S. Cl. CPC H04R 3/007; H04R 7/10; H04R 2307/027

(57) ABSTRACT

A condenser microphone unit and a condenser microphone are provided that can prevent intrusion of RF current into the condenser microphone unit. The condenser microphone unit includes an electroacoustic transducer 30 including a diaphragm 32 and a fixed electrode 33 that constitute a capacitor; a printed circuit board 50 including an impedance converter 40 connected to the electroacoustic transducer 30; and a unit case 20 having bottomed tubular shape and an opening, the electroacoustic transducer 30 and the printed circuit board 50 being installed in the interior of the unit case 20, a hole being formed on the printed circuit board 50 across the thickness of the printed circuit board 50, a first filter element L being inserted into the hole 50h, the first filter element L being connected to the impedance converter 40.

### TECHNICAL FIELD

The present invention relates to a condenser microphone unit and a condenser microphone.

### BACKGROUND ART

Some electret condenser microphone units (hereinafter, referred to as “units”) include field effect transistors (FET) that constitute impedance converters.

If such a unit receives intense electromagnetic waves from a mobile phone, for example, radio frequency (RF) current is generated and enter the unit. The FET detects the RF current and outputs noise in response. Various schemes have been proposed to prevent such noise generation (for example, refer to Japanese Unexamined Patent Application Publication No. 2010-288049).

An example scheme for prevention of such noise generation is to install capacitors on a printed circuit board (PCB) disposed in the interior of the unit for short-circuiting in a high-frequency manner. The effect of the short-circuiting in a high-frequency manner is frequency dependency based on the type and capacitance of the installed capacitors, for example. Thus, the scheme for the short-circuiting a PCB in a high-frequency manner involves the use of capacitors having different capacitances connected in parallel, for example.

FIG. 9 is a longitudinal cross-sectional schematic view of a conventional unit.

A unit 100 includes a unit case 200, an electroacoustic transducer 30, an impedance converter 40 of the electroacoustic transducer 30, and a PCB 500.

The unit case 200 is in a bottomed cylindrical shape and has an opening at the lower portion of the drawing. The unit case 200 is composed of pressed metal, such as aluminum. An acoustic-wave entering hole 200h is formed on the surface facing the opening of the unit case 200 (at the upper portion of the drawing) through which acoustic waves from a sound source pass.

The electroacoustic transducer 30 includes a spacer 31, a diaphragm 32, a fixed electrode 33, a diaphragm holder 34, and an insulator 35.

The diaphragm 32 and the fixed electrode 33 face each other with the spacer 31 disposed therebetween so as to constitute a capacitor. A layer of air having a thickness equivalent to that of the spacer 31 is formed between the diaphragm 32 and the fixed electrode 33.

The diaphragm 32 is a synthetic resin thin-film having a metal (preferably a gold) film deposited cm one side of the thin-film. The diaphragm 32 is provided on the diaphragm holder 34 with predetermined tension.

The fixed electrode 33 is a metal plate having multiple sound holes 33h through which acoustic waves pass. The fixed electrode 33 may he provided with an electret dielectric film. The fixed electrode 33 is fixed to the cylindrical insulator 35 composed of synthetic resin.

The disk shaped PCB 500 is disposed at the rear end of the unit case 200 such that the opening of the bottomed cylindrical shaped unit case 200 is closed from the inside. The PCB 500 is fixed in the interior of the unit case 200 by curling the rear edge portion of the case 200. The impedance converter 40 is disposed on one of the faces of the PCB 500 fixed in the interior of the unit case 200, and the face faces the interior of the unit case 200. A capacitor C1 is disposed on the other face of the PCB 500, and the other face faces the exterior of the unit case 200.

An FET 44 that constitutes the impedance converter 40 (see FIG. 10) includes a gate electrode 41, a drain electrode 42, and a source electrode 43. The gate electrode 41 is electrically connected to the fixed electrode 33. The drain electrode 42 and the source electrode 43 are aligned in the drawing, thus only one of these components are shown in the drawing.

A hole 500h is formed on the PCB 500 across the thickness of the PCB 500 (vertical direction in the drawing). The drain electrode 42 and the source electrode 43 are inserted in the hole 500h. Solder pads (signal lands SL and ground lands GL) to which the drain electrode 42 and the source electrode 43 are soldered by solder S are disposed on the other face of the PCB 500, faced the exterior of the unit case 200. A microphone cable (not shown) connects to the solder pads.

FIG. 10 illustrates an equivalent circuit of the conventional unit 100 in FIG. 9. FIG. 10 illustrates the capacitor C1 connected to the impedance converter 40 via the drain electrode 42 and the source electrode 43 of the FET 44. The capacitor C1 functions as a so-called bypass capacitor. The capacitor C1 is short-circuited (bypassed) to ground, so as to eliminate the RF current described above, and to prevent the PET 44 from detecting the RF current.

It is also considered to use the inductor for connection between the interior and exterior of the unit case 200 in order to improve the effectiveness of preventing the RF current from intruding the unit case 200. Unfortunately, an inductor disposed on the exterior of an electrostatic shield of the unit case 200 incompletely eliminates the RF current. Thus, this reduces the effectiveness of preventing the RF current from intruding the unit case 200. In contrast, an inductor disposed in the interior of the unit case 200 requires volume of an air chamber for the inductor disposed in the interior of the unit case 200. This precludes a reduction in the dimensions of the unit.

The PCB 500 of a nondirectional unit also serves as a seal of the air chamber in the interior of the bottomed cylindrical shaped unit case 200. For this reason, it is unfavorable for the PCB 500 of a nondirectional unit to have an opening (hole 500h). That is, the PCB 500 should seal the air chamber located in the rear of the diaphragm 32 without air leakage and should prevent the RF current from intruding into the unit case 200.

### SUMMARY OF INVENTION

### Technical Problem

An object of the present invention, which has been made to solve the problem described above, is to provide a condenser microphone unit and a condenser microphone that can prevent the RF current from intruding into the condenser microphone unit.

### Solution to Problem

A condenser microphone unit according to the present invention includes an electroacoustic transducer including a diaphragm and a fixed electrode that constitute a capacitor; a printed circuit board including an impedance converter connected to the electroacoustic transducer; and a bottomed tubular shaped unit case, the electroacoustic transducer and printed circuit board being disposed in the interior of the unit case, a hole is formed on the printed circuit board across the thickness of the printed circuit board, a first filter element being inserted in the hole, the first filter element being connected to the impedance converter.

The present invention can prevent the RF current from intruding into a condenser microphone unit.

### BRIEF DESCRIPTION OF DRAWINGS

FIG. 1 is a cross-sectional plan view illustrating an embodiment of a condenser microphone unit according to the present invention.

FIG. 2 is a cross-sectional plan view illustrating the condenser microphone unit having an insertion hole in a printed circuit board.

FIG. 3 is a cross-sectional plan view illustrating an example inductor inserted in the insertion hole.

FIG. 4 is a plan view illustrating the condenser microphone unit.

FIG. 5 is a bottom view of the condenser microphone unit.

FIG. 6 illustrates an equivalent circuit of the condenser microphone unit.

FIG. 7 is an external view illustrating an embodiment of a condenser microphone according to the present invention.

FIG. 8 is an exploded view of a component of the condenser microphone.

FIG. 9 is a cross-sectional plan view illustrating a conventional condenser microphone unit.

FIG. 10 illustrates an equivalent circuit of the conventional condenser microphone unit.

### DESCRIPTION OF EMBODIMENTS

Embodiments of a condenser microphone unit and a condenser microphone according to the present invention will now be described with reference to the accompanying drawings.

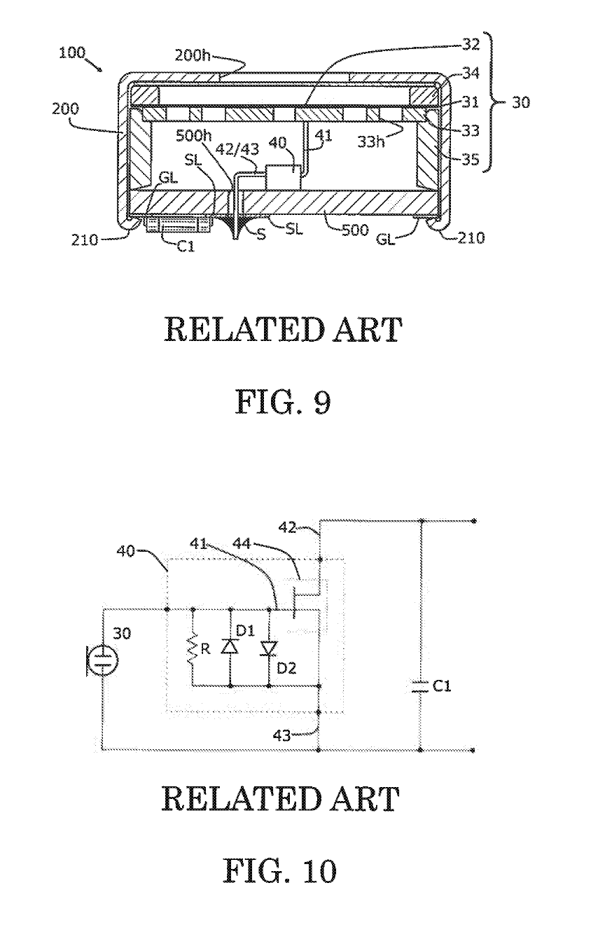

Among the components of the condenser microphone unit according to the present invention, the components that are the same as those of the conventional condenser microphone unit illustrated in FIGS. 9 and 10 are denoted by the same reference numerals.

### <Condenser Microphone Unit>

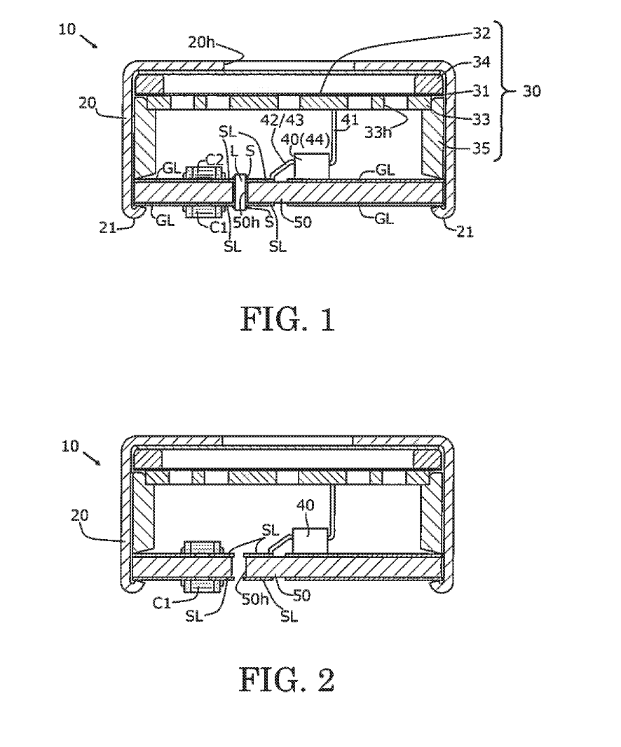

FIG. 1 is a cross-sectional plan view illustrating an embodiment of a condenser microphone unit (hereinafter, referred to as “unit”) according to the present invention.

The unit 10 includes a unit case 20, an electroacoustic transducer 30, an impedance converter 40, and a printed circuit board (PCB) 50.

The unit case 20 is in a bottomed cylindrical shape and is composed of pressed metal, such as aluminum. The unit case 20 defines the interior space of the unit case 20. The exterior of the unit case 20 is everything outside of the interior space of the unit case 20. The front end, or the bottom face of the unit case 20 (at the upper portion of the drawing) faces a sound source during sound collection. A sound entering hole 20h, which introduces acoustic waves from a sound source into the unit case 20, is formed on the front end of the unit case 20. An opening is formed on the rear end of the unit case 20 (at the lower portion of the drawing). The electroacoustic transducer 30 and the impedance converter 40 are accommodated in the interior of the unit case 20 through this opening.

The electroacoustic transducer 30 includes a spacer 31, a diaphragm 32, a fixed electrode 33, a diaphragm holder 34, and an insulator 35. The diaphragm 32 and the fixed electrode 33 face each other with the spacer 31 disposed therebetween. The spacer 31 is composed of thin synthetic resin, for example, and is in an annular shape in plan view. A layer of air (gap) having a thickness equivalent to that of the spacer 31 is formed between the diaphragm 32 and the fixed electrode 33.

The diaphragm 32 is composed of a thin synthetic-resin film, for example, and is in a round shape in plan view. The diaphragm 32 is provided on a diaphragm holder (diaphragm ring) 34, which is in an annular shape in plan view, with predetermined tension.

The fixed electrode 33 has multiple sound holes 33h through which acoustic waves pass and is composed of a metal plate, which is in a round shape in plan view. The fixed electrode 33 and the opposite diaphragm 32 constitute a capacitor. The fixed electrode 33 is provided with an electret plate on at least one of the surfaces, for example, on the surface facing the diaphragm 32, and constitutes an electret board. The fixed electrode 33 is fixed to a cylindrical shaped insulator 35 composed of synthetic resin.

The impedance converter 40 is an impedance converter of the electroacoustic transducer 30. A field effect transistor (FET) 44 that constitutes the impedance converter 40 includes a gate electrode 41, a drain electrode 42, and a source electrode 43. The gate electrode 41 is electrically connected to the fixed electrode 33. The drain electrode 42 and the source electrode 43 are aligned in the drawings, thus only one of these components is shown in the drawings.

The PCB 50 is fixed in the interior of the unit case 20 and has a first face faces the interior space of the unit case 20 and a second face faces the exterior of the unit case 20. The PCB 50 is composed of a plate that is in a round shape in plan view. The PCB 50 is disposed at the opening of the unit case 20 such that the opening of the unit case 20 is closed from the inside. The PCB 50 is fixed in the interior of the unit case 20 by curling the rear edge portion of the unit case 20. Through such curling, a curled portion 21 is formed at the rear edge portion of the unit case 20. Solder pads (signal lands SL and ground lands GL) are disposed on the PCB 50, the drain electrode 42 and the source electrode 43 are soldered to the solder pads by the solder S.

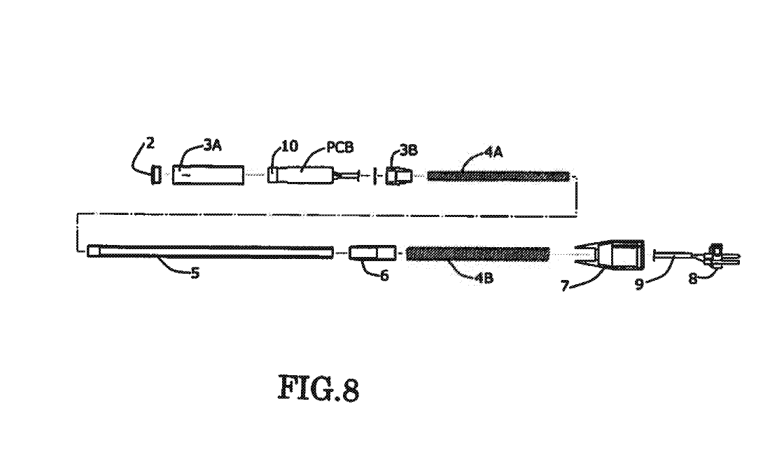

The PCB 50 is connected to an audio-signal output printed circuit board PCB (see FIG. 8) described below via a cable (not shown). The cable may be a double-core shielded cable including a feeder line, a signal line, and a shielding braided wire. Audio signals from the unit 10 are output to the audio-signal output printed circuit board PCB via such a cable. The feeder line is connected to the drain electrode 42. The signal line is connected to the source electrode 43. The shielding braided wire is connected to a grounding pattern (grounding land GL) of the PCB 50. The power supply supplying power to the drain electrode 42 is a phantom power supply, for example.

The impedance converter 40 is disposed on the first face of the PCB 50. A capacitor C1 as a second filter element is disposed on the second face of the PCB 50.

FIG. 2 is a cross-sectional plan view illustrating an insertion hole provided in the PCB 50. With reference to FIG. 2, the PCB 50 has the insertion hole 50h, which is not provided for electrical connection, across the thickness (vertical direction in the drawing) of the PCB 50. The PCB 50 is fixed to the interior of the unit case 20 and the insertion hole 50h communicates between the interior and the exterior of the unit case 20.

The signal lands SL are formed at the peripheral areas (circumferential areas) of the insertion hole 50h on the first and second faces of the PCB 50.

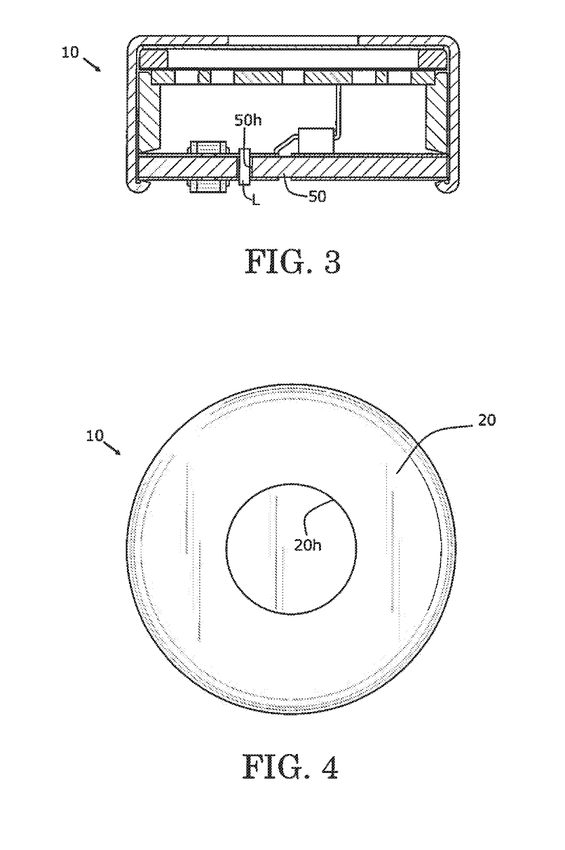

FIG. 3 is a cross-sectional plan view illustrating an example inductor inserted into the insertion hole 50h. With reference to FIG. 3, a chip coil (inductor) L as a first filter element is inserted in the insertion hole 50h.

After the chip coil L is inserted in the insertion hole 50h, both ends of the chip coil L inserted in the insertion hole 50h are soldered to the signal lands SL by the solder S, as illustrated in FIG. 1, and the gap between the insertion hole 50h and chip coil L is sealed. Specifically, the insertion hole 50h is sealed by the solder S disposed between the chip coil L and the solder pads. The air in the interior of the unit case 20 does not leak outside of the unit case 20 through the insertion hole 50h. In other words, an air chamber is formed in the interior of the unit case 20.

As described above, both ends (at the upper and lower portions of the drawing) of the chip coil L inserted into the insertion hole 50h are soldered to the signal lands SL by the solder S. As a result, the capacitor C1, the chip coil L, and the impedance converter 40 are electrically connected, and the capacitor C1 and the chip coil L seal the air chamber.

FIG. 4 is a plan view of the unit 10. With reference to FIG. 4, the acoustic-wave entering hole 20h is formed in the central area of the front end of the unit case 20.

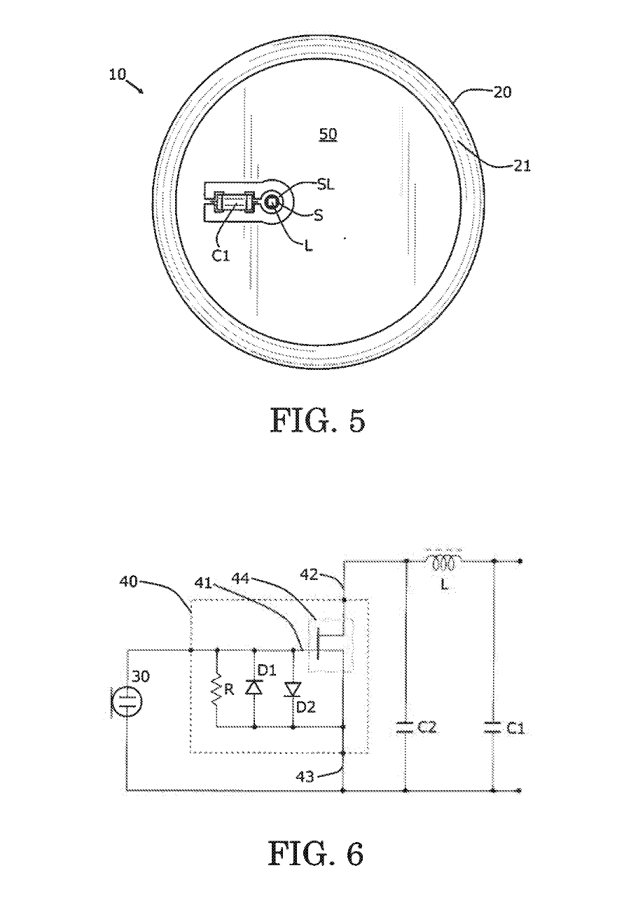

FIG. 5 is a bottom view of the unit 10, With reference to FIG. 5, the chip coil L inserted in the insertion hole 50h in the PCB 50 is soldered to the signal land SL in the peripheral area of the insertion hole 50h on the second face of the PCB 50 by the solder S, such that the chip coil L is electrically connected to the capacitor C1.

Referring now back to FIG. 1, a capacitor C2 as a third filter element is disposed on the first face of the PCB 50. The chip coil L is soldered to the signal land SL in the peripheral area of the insertion hole 50h on the first face of the PCB 50 by the solder S, and the chip coil L is electrically connected to the capacitor C2. As a result, the capacitor C1, the chip coil L, and the capacitor C2 constitute a n filter.

FIG. 6 illustrates an equivalent circuit of the unit 10 installing a π filter composed of the capacitor C1, the chip coil L, and the capacitor C2. FIG. 6 illustrates the chip coil L connecting to the impedance converter 40 in series. FIG. 6 also illustrates the capacitor C1 connecting to the impedance converter 40, which includes a resistor R and diodes D1 and D2, via the chip coil L. FIG. 6 also illustrates the capacitor C2 connecting to the FET 44 via the drain electrode 42 and the source electrode 43. The capacitors C1 and C2 are short-circuited (bypassed) to ground, so as to eliminate the RF current described above, and to prevents the FET 44 from detecting the RF current.

According to the embodiment described above, the chip coil L is embedded and installed in the PCB 50. Thus, it prevents the RF current described above from intruding into the interior of the unit case 20 without a chip coil L disposed on the outer face of the electrostatic shield of the unit case 20.

The chip coil L is embedded and installed in the PCB 50, thus a certain volume of the air chamber in the interior of the unit case 20 is maintained. That is, installing the chip coil L in the PCB 50 allows miniaturization of the unit 10. Further, the circuit components of the unit 10 is placed in the three-dimension. As a result, the circuit pattern of the unit 10 is simplified and the unit 10 is less susceptible to external noise.

### <Condenser Microphone>

An embodiment of a condenser microphone according to the present invention will now be described.

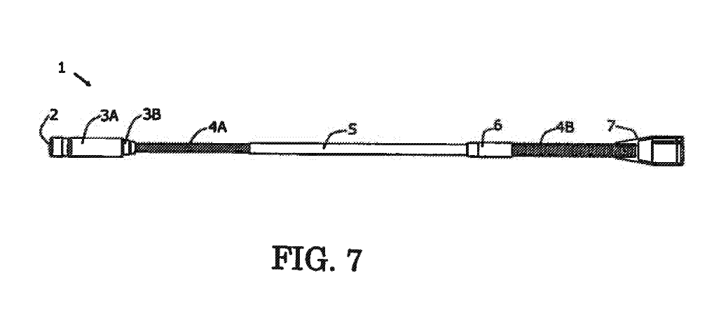

FIG. 7 is an external view illustrating an embodiment of a condenser microphone according to the present invention. FIG. 8 is an exploded view of a component of the condenser microphone in FIG. 7.

A condenser microphone 1 according to the present invention is, for example, of a gooseneck type, and includes a cap 2, a microphone case 3A, a microphone case 3B, a gooseneck pipe 4A, a pipe 5, a joint 6, a gooseneck pipe 4B, and a connector case 7. The present invention will now be exemplified with a gooseneck condenser microphone. The condenser microphone according to the present invention may be applied not only the gooseneck type, but also to other microphones required to be compact microphone units, such as lavalier microphones and wireless microphones.

With reference to FIG. 8, the condenser microphone unit 10 according to the present invention described above and an audio-signal output printed circuit board PCB for the unit 10 are accommodated in the microphone case 3A. The cap 2 covers one end of the microphone case 3A (at the lower portion of the drawing), which is to be pointed toward a sound source during sound collection. The bendable gooseneck pipe 4A connects with the other end of the microphone case 3A (at the upper portion of the drawing) via the microphone case 3B. One end of the pipe 5, which is a metal straight pipe, connects with the gooseneck pipe 4A. The bendable gooseneck pipe 4B connects with the other end of the pipe 5 via the joint 6. The connector case 7 accommodating a connector 8 connects with the other end of the gooseneck pipe 4B.

The connector 8 is, for example, an output connector including a first pin for ground, a second pin for hot signals, and a third pin for cold signals, and conforms to JEITA Standard RC-5236 “Circular Connectors, Latch Lock Type for Audio Equipment.”

The audio-signal output printed circuit board PCB includes a balanced transmission circuit. The audio-signal output printed circuit board PCB and the connector 8 are electrically connected via a microphone cable 9. The microphone cable 9 is inserted into the gooseneck pipes 4A and 4B and the pipe 5. The microphone cable 9 is a double-core shielded cable including two types of signal lines, hot and cold, and a shielding braided wire.

The shielding braided wire of the microphone cable 9 is connected to the ground (grounding circuit) of the audio-signal output printed circuit board PCB, for example. The ground of the audio-signal output printed circuit board PCB is connected to the first pin of the connector 8. The first pin is also connected to a shielded case (not shown). The connector 8 and the microphone cable 9 are connected as described below. That is, the hot signal line of the microphone cable 9 is connected to the second pin of the connector 8. The cold signal line of the microphone cable 9 is connected to the third pin of the connector 8. The shielding braided wire is connected to the first pin of the connector 8.

The condenser microphone unit 10 includes an FET 44 including a gate electrode 41, a drain electrode 42, and a source electrode 43, as described above. The two signal lines of the microphone cable 9 are connected to the source electrode 43 via the audio-signal output printed circuit board PCB. The audio signals output from the FET 44 are unbalanced signals. The audio signals output as unbalanced signals from the FET 44 are converted to balanced signals at the audio-signal output printed circuit board PCB and sent to the microphone cable 9.

The condenser microphone unit 10 of the condenser microphone 1 is the condenser microphone unit of the present invention described above. Thus, as described above, the condenser microphone according to the present invention prevents the RF current from intruding into the condenser microphone unit, thereby prevents noise.

1. A condenser microphone unit comprising:
an electroacoustic transducer comprising a diaphragm and a fixed electrode, the diaphragm and the fixed electrode constituting a capacitor;
a printed circuit board comprising an impedance converter connected to the electroacoustic transducer; and
a unit case having bottomed tubular shape and an opening, the electroacoustic transducer and printed circuit board being installed in the interior of the unit case,
a hole being formed on the printed circuit board across the thickness of the printed circuit board, a first filter element being inserted into the hole,
the first filter element being connected to the impedance converter.

2. The condenser microphone unit according to claim 1, wherein,
the unit case is configured to define an interior space,
the printed circuit board has a first face and a second face, the impedance converter being disposed on the first face and a second filter element being disposed on the second face, and
the printed circuit board covers the opening such that the first face faces the interior space of the unit case and the second face faces an exterior of the unit case.

3. The condenser microphone unit according to claim 1, wherein a solder pad is formed around the hole.

4. The condenser microphone unit according to claim 3, wherein,
the hole is sealed by solder between the first filter element inserted into the hole and the solder pad, and
an air chamber is formed in the interior of the unit case.

5. The condenser microphone unit according to claim 2, wherein the type of the first filter element differs from the type of the second filter element.

6. The condenser microphone unit according to claim 2, wherein,
a third filter element is disposed on the first face, and
the third filter element is connected to the first filter element.

7. The condenser microphone unit according to claim 6, wherein the type of the first filter element differs from the type of the third filter element.

8. The condenser microphone unit according to claim 6, wherein the type of the second filter element is the same as the type of the third filter element.

9. The condenser microphone unit according to claim 6, wherein,
the first filter element comprises an inductor,
the second filter element comprises a capacitor, and
the third filter element comprises a capacitor.

10. A condenser microphone comprising:
a condenser microphone unit; and
a microphone case that accommodates the condenser microphone unit.
the condenser microphone unit being the condenser microphone unit according to claim 1.
